(19) United States
(12) Patent Application Publication
(10) Pub. No.: US 2011/0050822 A1
(43) Pub. Date: Mar. 3, 2011

(54) PRINTING SYSTEM

(75) Inventors: Kazutoshi FUJISAWA, Okaya-shi (JP); Shinichi KAMOSHIDA, Shiojiri-shi (JP)

(73) Assignee: Seiko Epson Corporation, Tokyo (JP)

(21) Appl. No.: 12/861,047

(22) Filed: Aug. 23, 2010

(30) Foreign Application Priority Data
Aug. 26, 2009 (JP) 2009-195939
May 18, 2010 (JP) 2010-114549

(51) Int. Cl. B41J 2/01

(52) U.S. Cl. 347/102

(57) ABSTRACT

A printing system includes a temporary-curing light source radiating temporary-curing light to dots formed on a medium, and a complete-curing light source radiating complete-curing light to the dots irradiated with the temporary-curing light and having a wavelength band different from that of the temporary-curing light source. In the printing system described above, ink used for forming the dots includes at least two types of photopolymerization initiators which photopolymerize a monomer when being irradiated with light, and the two types of photopolymerization initiators have absorption peaks at different wavelengths.

### BACKGROUND

1. Technical Field

The present invention relates to a printing system.

2. Related Art

As one type of ink used for printing, there is a photocurable ink such as an ultraviolet (UV) ink which is cured by irradiation of light (one type of electromagnetic wave, such as UV rays). When a photocurable ink is used, an ink landed on a medium is cured by irradiation of light; hence, even on a medium which is not likely to absorb ink, desirable printing can be performed.

Color printing or the like uses a plurality of photocurable inks of different colors. A printing method used in such color printing has been proposed in which each time photocurable ink having a different color is ejected on a medium, light is radiated from a temporary-curing light source to cure the ink (temporary curing), and light is finally radiated from a complete-curing light source to completely cure the ink (complete curing) (for example, see JP-A-2008-105268). By the method described above, a blur between different colors can be suppressed.

However, according to the printing method described above, the number of radiations of light for temporary curing may be different among inks (dots) having different colors, and as a result, the number of temporary curings may influence the image quality in some cases. For example, a dot having received a large number of radiations of light for temporary curing is progressively cured, and hence the dot is liable to reject ink. As a result, a dot formed on the dot thus cured has a smaller diameter. In addition, depending on the number of temporary curings, dots having different colors may have different shapes therebetween. As described above, depending on the difference in the number of temporary curings, the image quality may be degraded in some cases.

### SUMMARY

An advantage of some aspects of the invention is to prevent the degradation in image quality.

The invention provides a printing system including a temporary-curing light source radiating temporary-curing light to dots formed on a medium and a complete-curing light source radiating complete-curing light to the dots irradiated with the temporary-curing light and having a wavelength band different from that of the temporary-curing light source, and in this printing system, ink used for forming the dots includes at least two types of photopolymerization initiators which photopolymerize a monomer when being irradiated with light, and the two types of photopolymerization initiators have absorption peaks at different wavelengths.

Other features of the invention will become more clear through this specification and the accompanying drawings.

### BRIEF DESCRIPTION OF THE DRAWINGS

The invention will be described with reference to the accompanying drawings, wherein like numbers reference like elements.

FIG. 1 is a block diagram showing the entire structure of a printer.

FIG. 2 is a schematic view showing the area around a printing region.

FIG. 3 is a view illustrating the placement of nozzles of each head.

FIG. 4 is a view illustrating properties of a UV ink.

FIG. 5 is a graph showing a light emission distribution of a light source of a temporary-curing radiation portion.

FIG. 6 is a graph showing a light emission distribution of a light source of a complete-curing radiation portion.

FIG. 7 is a table showing compositions of UV inks of this embodiment.

FIG. 8 is a graph showing absorption characteristics of each photopolymerization initiator.

FIG. 9 is a graph showing the relationship between a polymerization conversion ratio and the amount of light (amount of UV radiation) for temporary curing.

### DESCRIPTION OF EXEMPLARY EMBODIMENTS

According to this specification and the accompanying drawings, at least the following points will become apparent.

The invention provides a printing system including a temporary-curing light source radiating temporary-curing light to dots formed on a medium and a complete-curing light source radiating complete-curing light to the dots irradiated with the temporary-curing light and having a wavelength band different from that of the temporary-curing light source, and in this printing system, ink used for forming the dots includes at least two types of photopolymerization initiators which photopolymerize a monomer when being irradiated with light, and the two types of photopolymerization initiators have absorption peaks at different wavelengths.

According to the printing system as described above, degradation in image quality can be prevented.

In the printing system described above, the complete-curing light source and the temporary-curing light source preferably have wavelength distributions different from each other. The two types of photopolymerization initiators are preferably a first photopolymerization initiator which is likely to generate radicals by radiation of light from the temporary-curing light source and a second photopolymerization initiator which is likely to generate radicals by radiation of light from the complete-curing light source. A polymerization conversion ratio of the monomer by the complete-curing light source is preferably higher than that of the monomer by the temporary-curing light source.

According to the printing system described above, the dots can reliably be cured by the complete curing.

In the printing system described above, the temporary-curing light source preferably has a single peak at approximately 390 nm, and the complete-curing light source preferably has a plurality of peaks in the wavelength range of 200 to 600 nm. The two types of photopolymerization initiators preferably include one of Irgacure-784, Irgacure-819, and Chemcure-TPO as the first photopolymerization initiator which is likely to generate radicals by radiation of light from the temporary-curing light source and one of Chemcure-709 and Chemcure-73 as the second photopolymerization initiator which is likely to generate radicals by radiation of light from the complete-curing light source.

According to the printing system described above, regardless of the number of temporary curings, the curing may not be completed by the temporary curing but can be achieved by the complete curing.

In the printing system described above, the ink preferably contains 0.2 to 0.5 percent by mass of the first photopolymerization initiator and 4 to 5 percent by mass of the second photopolymerization initiator.

According to the printing system described above, even the ink through a large number of temporary curings can be prevented from completely curing.

Hereinafter, an embodiment will be described in which a line printer (printer 1) is used as an example of a printing system using a photocurable ink.

### Outline of Printer

### Structure of Printer

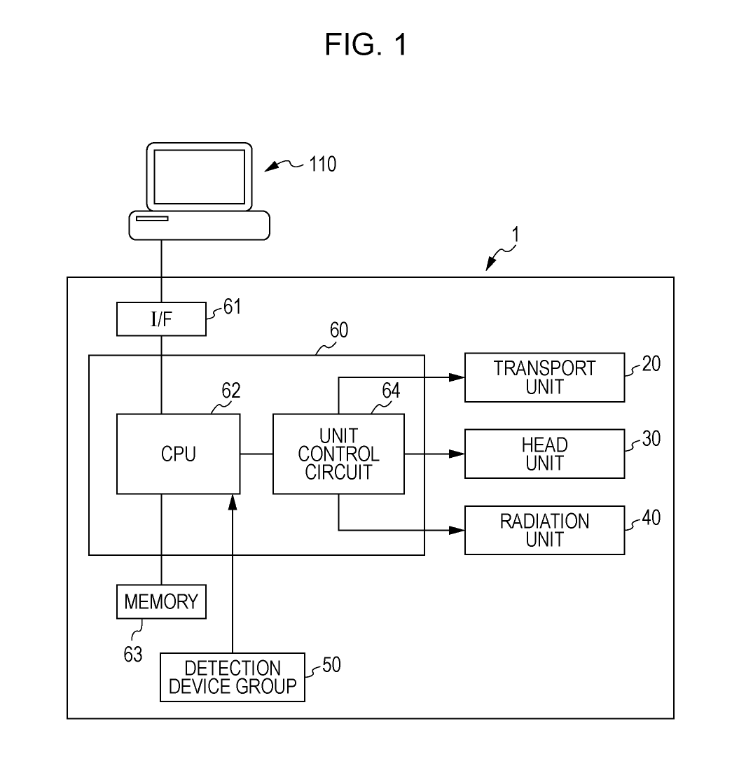

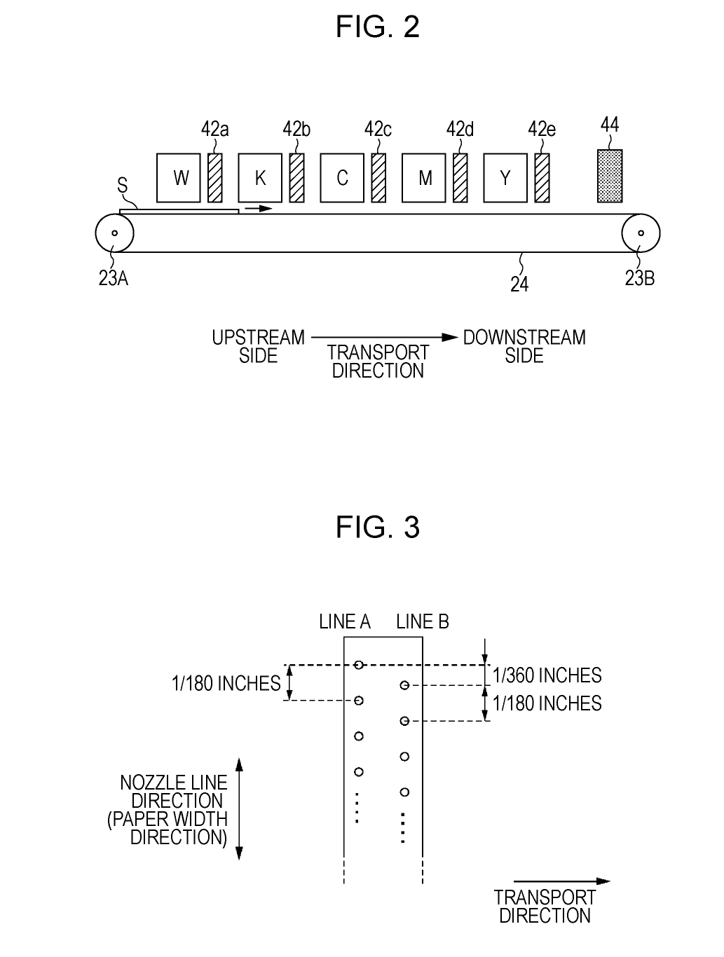

FIG. 1 is a block diagram showing the entire structure of the printer 1. FIG. 2 is a schematic view showing the area around a printing region of the printer 1.

The printer 1 is a printing device printing an image on a medium, such as paper, cloth, or a film, and is connected to and communicates with a computer 110 functioning as an external device.

A printer driver is installed in the computer 110. The printer driver is a program which causes a display device (not shown) to display a user interface and which converts image data output from an application program into printing data. The printer driver is recorded in a recording medium (computer readable recording medium) such as a flexible disc (FD) or a CD-ROM. The printer driver can be downloaded to the computer 110 from the Internet. This program includes codes for realizing various functions.

The computer 110 outputs to the printer 1 printing data corresponding to an image to be printed in the printer 1.

The printer 1 is a device printing an image on a medium by ejecting an ultraviolet curable ink (UV ink, hereinafter simply referred to as “ink” in some cases) which is cured by irradiation of ultraviolet rays (hereinafter referred to as “UV”). The UV ink is prepared by adding auxiliary agents, such as a polymerization inhibitor and a surfactant, to a mixture of an oligomer or monomer having photopolymerization curing properties, a photopolymerization initiator, and a pigment. The details of the UV ink will be described later. The ink is either a water-based ink or an oil-based ink. The UV ink is cured by a photopolymerization reaction which occurs when the ink is irradiated with UV. The printer 1 of this embodiment prints an image using five color UV inks, that is, a cyan, a magenta, a yellow, a black, and a white UV ink.

The printer 1 includes a transport unit 20, a head unit 30, a radiation unit 40, a detection device group 50, and a controller 60. Upon receiving printing data from the computer 110 that is an external device, the printer 1 controls the individual units (the transport unit 20, the head unit 30, and the radiation unit 40) by the controller 60 and prints an image on a medium in accordance with the printing data. The controller 60 controls the individual units based on the printing data received from the computer 110 to print the image on the medium. The detection device group 50 monitors conditions inside the printer 1 and outputs detection results to the controller 60. The controller 60 controls the individual units based on the detection results output from the detection device group 50.

The transport unit 20 is a unit to transport a medium (such as paper) in a predetermined direction (hereinafter referred to as “transport direction”). The transport unit 20 has an upstream side transport roller 23A, a downstream side transport roller 23B, and a belt 24. When a transport motor (not shown) is rotated, the upstream side transport roller 23A and the downstream side transport roller 23B are rotated, so that the belt 24 is rotated. The belt 24 transports a medium supplied by a feed roller (not shown) to a printable region (region facing a head). Since the belt 24 transports the medium, the medium is moved in the transport direction to the head unit 30. The medium passing through the printable region is discharged outside the printer 1 by the belt 24. While being transported, the medium is electrostatically adsorbed or vacuum adsorbed to the belt 24.

The head unit 30 is a unit to eject UV ink to a medium. In this embodiment, five color UV inks, that is, a cyan, a magenta, a yellow, a black, and a white ink, are used to form an image. The head unit 30 ejects the individual inks to a medium being transported, and forms dots on the medium, so that an image is printed thereon. In this embodiment, as shown in FIG. 2, a white ink head W ejecting a white UV ink (white ink), a black ink head K ejecting a black UV ink, a cyan ink head C ejecting a cyan UV ink, a magenta ink head M ejecting a magenta UV ink, and a yellow ink head Y ejecting a yellow UV ink are provided in that order from the upstream side in the transport direction. The printer 1 of this embodiment is a line printer, and each head of the head unit 30 can form dots in the width direction of the medium at a time.

The radiation unit 40 is a unit radiating UV to UV ink droplets landed on a medium. A dot formed on the medium is irradiated and cured with UV emitted from the radiation unit 40. The radiation unit 40 of this embodiment includes a temporary-curing radiation portion 42 and a complete-curing radiation portion 44 and performs a two-stage curing (UV radiation) including temporary curing and complete curing to a dot formed on a medium.

The temporary-curing radiation portion 42 radiates UV to temporarily cure a dot formed on a medium. In this embodiment, the temporary curing is a curing performed to suppress a blur between inks and a spread of dots. However, even after the temporary curing, the ink is not completely solidified. The temporary-curing radiation portion 42 in the printer 1 of this embodiment has a first radiation section 42a, a second radiation section 42b, a third radiation section 42c, a fourth radiation section 42d, and a fifth radiation section 42e.

The first radiation section 42a is provided at a downstream side of the white ink head W in the transport direction, and the second radiation section 42b is provided at a downstream side of the black ink head K in the transport direction. The third radiation section 42c is provided at a downstream side of the cyan ink head C in the transport direction, and the fourth radiation section 42d is provided at a downstream side of the magenta ink head M in the transport direction. The fifth radiation section 42e is provided at a downstream side of the yellow head Y in the transport direction.

The length of each radiation section in a medium width direction is equal to or more than the width of the medium. The radiation sections radiate UV to dots formed by the respective heads of the head unit 30.

The details of the temporary-curing radiation portion 42 will be described later.

The complete-curing radiation portion 44 radiates UV to completely cure dots formed on a medium. In this embodiment, the complete curing is a curing performed to completely solidify the dots.

The complete-curing radiation portion 44 is provided at a downstream side of the fifth radiation section 42e of the temporary-curing radiation portion 42 in the transport direction. The length of the complete-curing radiation portion 44 in the medium width direction is equal to or more than the width of the medium. The complete-curing radiation portion 44 radiates UV to dots formed by the individual heads of the head unit 30.

The details of the complete-curing radiation portion 44 will be described later.

The detection device group 50 includes a rotary encoder (not shown), a paper detection sensor (not shown) and the like. The rotary encoder detects the number of rotations of the upstream side transport roller 23A and the downstream side transport roller 23B. The amount of transport of a medium can be detected based on the detection results of the rotary encoder. The paper detection sensor detects a front end position of a medium being transported.

The controller 60 is a control unit (control portion) controlling the printer. The controller 60 includes an interface portion 61, a CPU 62, a memory 63, and a unit control circuit 64. The interface portion 61 is used to send and receive data between the computer 110 that is an external device and the printer 1. The CPU 62 is an arithmetic processing device to control the entire printer. The memory 63 is provided for storing programs of the CPU 62 and provided as a working area or the like for the programs, and includes memory elements, such as a RAM and an EEPROM. The CPU 62 controls the individual units through the unit control circuit 64 in accordance with the programs stored in the memory 63.

### Printing Operation

When the printer 1 receives printing data from the computer 110, the controller 60 first rotates a feed roller (not shown) using the transport unit 20 to send a medium to be printed onto the belt 24. The medium is transported on the belt 24 at a predetermined rate without being stopped and passes under the head unit 30 and the radiation unit 40. During this period, the controller 60 causes the individual heads of the head unit 30 to intermittently eject ink from nozzles thereof to form dots on the medium and also causes the individual radiation portions of the radiation unit 40 to radiate UV. Accordingly, an image is printed on the medium. Subsequently, the controller 60 discharges the medium on which the image is printed.

### Placement of Nozzles of Each Head

FIG. 3 is a view illustrating the placement of nozzles of each head. Each head has, as shown in FIG. 3, two lines of nozzles, that is, a “line A” and a “line B”.

Nozzles of each line are disposed with intervals of 1/180 inches (nozzle pitch) in a direction (nozzle line direction) which intersects the transport direction. The positions of nozzles of the line A in the nozzle line direction are shifted from the positions of nozzles of the line B in the nozzle line direction by a half nozzle pitch ( 1/360 inches). Accordingly, dots of the individual colors can be formed at a resolution of 1/360 inches.

### Temporary Curing and Complete Curing

The printer 1 of this embodiment includes the radiation unit 40 having the temporary-curing radiation portion 42 and the complete-curing radiation portion 44 and performing after the formation of dots the two-stage curing including temporary curing and complete curing. Hereinafter, the function of each curing will be described.

The temporary curing is a curing performed to suppress a blur between inks and a spread of dots. In this temporary curing, the amount of radiation of UV to dots is small, and even after the temporary curing, the UV ink (dot) is not completely solidified. The amount of radiation (mJ/cm²) is the product of the radiation intensity (mW/cm²) and the radiation time (sec). In this embodiment, since the rate of transporting a medium is constant (the time of UV radiation by each radiation section is constant), the amount of radiation depends on the radiation intensity. When the amount of radiation is adjusted, the shapes of dots can be adjusted.

When a large amount of UV is radiated (the radiation intensity is high), a blur between inks and a spread of dots can be suppressed. However, since irregularities caused on the surface of dots may increase, the medium may lose the gloss.

On the other hand, when a small amount of UV is radiated (the radiation intensity is low), the gloss may be suitable. However, a blur is liable to occur between inks of different colors.

The complete curing is a curing performed to completely solidify ink. The amount of UV radiated in the complete curing is larger than in the temporary curing.

Relationship between Number of Temporary Curings and Dot Shape

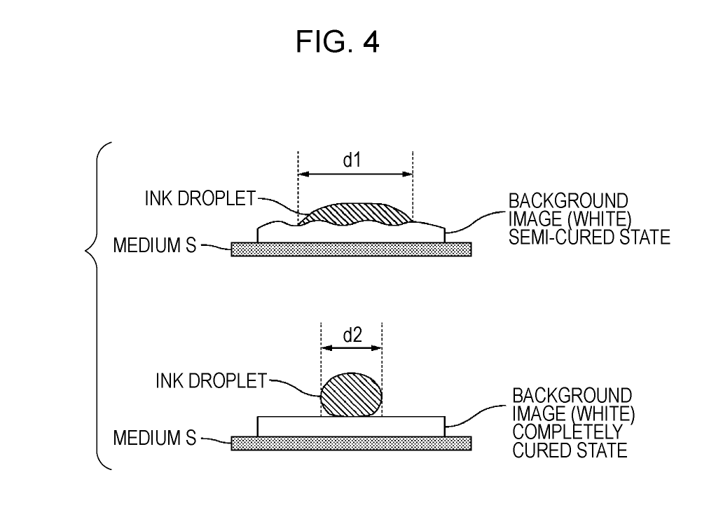

FIG. 4 is a view illustrating properties of UV ink. FIG. 4 illustrates the state in which a background image (underlying image) is formed by a white ink on a medium S (such as a film), and then an ink of a different color (such as a yellow, a magenta, a cyan, or a black color (YMCK)) is ejected on the background image. An upper side of FIG. 4 shows the state in which the ink for the underlying image is not completely cured (hereinafter also referred to as “semi-cured state”). On the other hand, a lower side of FIG. 4 shows the state in which the ink for the underlying image is completely cured (hereinafter referred to as “completely cured state”).

The higher the degree of curing of a UV ink becomes by UV radiation, the more the UV ink tends to reject an ink droplet formed thereon. Accordingly, as shown in FIG. 4, an ink droplet ejected on a semi-cured ink flows and spreads on the surface of the underlying image (wets the surface and spreads thereon). On the other hand, an ink droplet ejected on a completely cured underlying image does not flow and spread on the surface of the underlying image and forms into a round grain shape. When the ink droplet in this state is irradiated with UV, compared to a dot diameter “d1” of the ink droplet ejected on the background image in a semi-cured state, a dot diameter “d2” of the ink droplet ejected on the completely cured background image becomes small. In addition, compared to the ink droplet ejected on the completely cured background image, the ink droplet ejected on the semi-cured background image has a strong bond to the background image, and as a result, an upper side ink is not likely to be peeled off.

In this embodiment, the radiation sections (42a to 42e) of the temporary-curing radiation portion 42 are provided at the downstream side of the respective heads in the transport direction. In this arrangement, the number of UV radiations for temporary curing performed to dots formed by the individual heads differs depending on a printing mode.

For example, in a “monochromatic printing mode”, an image (text or the like) is printed only by a black ink on a white (white ink) background image. In this mode, the black ink is the last ink to be ejected, and until the black ink is ejected, the background image (dot formed by the white ink head W) is irradiated with UV emitted from the first radiation section 42a.

In a “three-color printing mode”, a color image is printed with three color inks (a yellow ink, a magenta ink, and a cyan ink) on a white background image. As shown in FIG. 2, among the heads ejecting three inks YMC, a yellow ink head Y ejecting a yellow ink is located at the most downstream side in the transport direction. Hence, in the three-color printing mode, the yellow ink is the last ink to be ejected. As apparent from FIG. 2, until the yellow ink is ejected, the background image (a dot formed by the white ink head W) is irradiated with UV emitted from the first radiation section 42a, the third radiation section 42c, and the fourth radiation section 42d. In this mode, there is a fear that the background image (white ink) may be completely cured before the yellow ink is ejected.

When the underlying UV ink is completely cured as described above, the size of a dot formed thereon by another UV ink becomes smaller than a predetermined size. As a result, when the image is macroscopically viewed, the density of the image with dots formed later by UV ink may become pale, or the width of a ruled line may become small.

In addition, the temporary-curing radiation portion 42 has five radiation sections in this embodiment. The more radiation sections are provided, the more differences in number of UV radiations for temporary curing are between dots formed by the individual heads. That is, a dot formed by a head at the upstream side in the transport direction receives a large number of UV radiations for temporary curing, and a dot formed by a head at the downstream side in the transport direction receives a small number of UV radiations for temporary curing. As described above, since dots having different colors receive different number of UV radiations, the shapes of dots may be different from each other, and as a result, the image quality may be affected in some cases.

Accordingly, in this embodiment, the printer is configured such that ink is not completely cured even if the UV radiation for temporary curing is repeatedly performed, thereby suppressing the degradation in image quality of a printed image.

Before the ink of this embodiment is described, characteristics of light sources of the temporary-curing radiation portion 42 and the complete-curing radiation portion 44 will be described.

### Temporary-Curing Radiation Portion

Each of the individual radiation sections (42a to 42e) of the temporary-curing radiation portion 42 of this embodiment includes a light emitting diode (LED) as a light source of UV radiation. An LED can easily change radiation energy by controlling the amount of current input thereto.

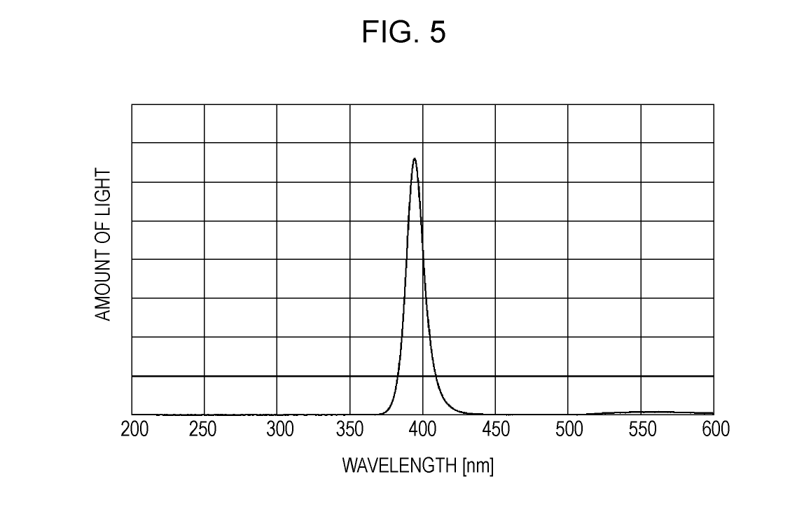

FIG. 5 is a graph showing a light emission distribution of the light source of the temporary-curing radiation portion 42 of this embodiment.

In FIG. 5, the vertical axis indicates the amount of light, and the horizontal axis indicates the wavelength of light. As shown in FIG. 5, the amount of light increases at a wavelength in the range of approximately 370 to 430 nm (the amount of light is maximized at a wavelength of approximately 390 nm). In addition, the amount of light is small at the other wavelengths.

As described above, the light source of the temporary-curing radiation portion 42 has a single peak at a predetermined wavelength (approximately 390 nm).

### Complete-Curing Radiation Portion

The complete-curing radiation portion 44 of this embodiment includes a metal halide lamp as a light source of UV radiation. Another light source (such as a mercury lamp, a xenon lamp, a carbon arc lamp, or a chemical lamp) may also be used.

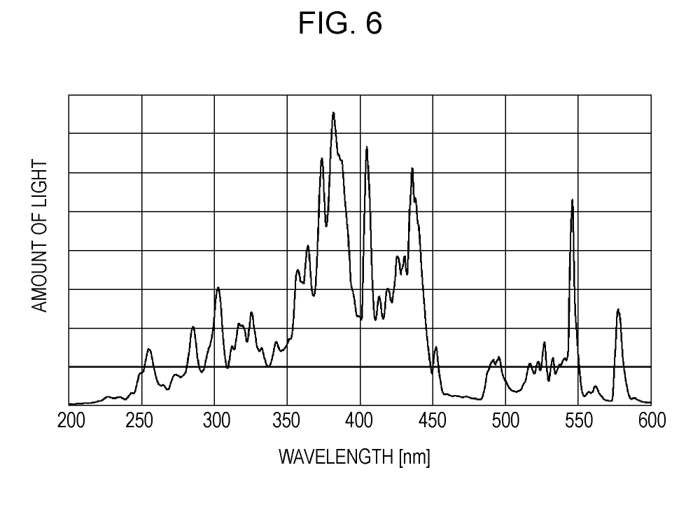

FIG. 6 is a graph showing a light emission distribution of the light source of the complete-curing radiation portion 44 of this embodiment.

In FIG. 6, the vertical axis indicates the amount of light, and the horizontal axis indicates the wavelength of light. As shown in FIG. 6, although the amount of light is maximized at a wavelength of approximately 360 nm, the light source of the complete-curing radiation portion 44 has a plurality of peaks from a short wavelength side (200 nm) to a long wavelength side (600 nm).

As described above, the light source of the complete-curing radiation portion 44 has a wide wavelength band as compared to the light source of the temporary-curing radiation portion 42 (FIG. 5).

### UV Ink

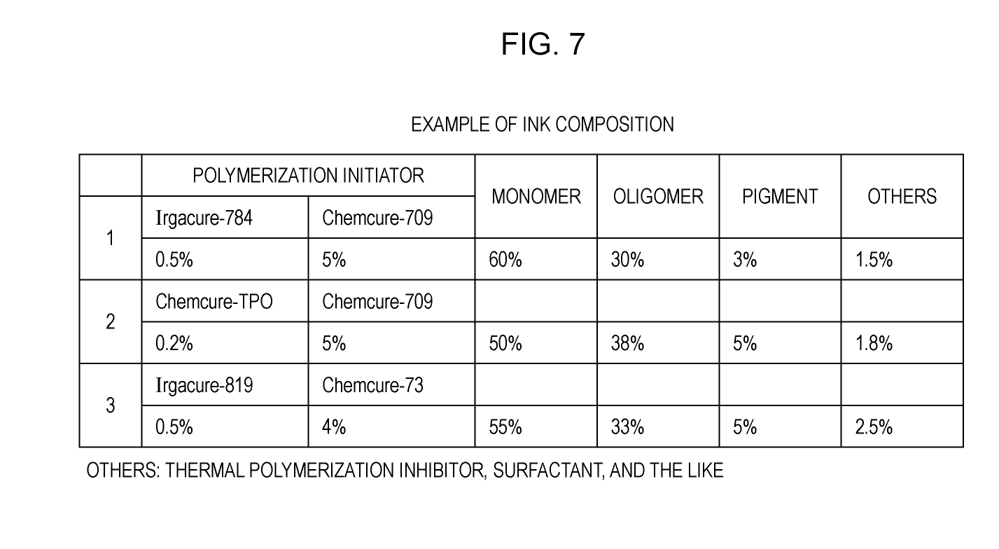

FIG. 7 is a table showing compositions of UV inks of this embodiment.

Ink compositions 1 to 3 of this embodiment each include two types of photopolymerization initiators, a monomer, an oligomer, a pigment, and the like. A radical polymerization method or a cationic polymerization method is selected as a reaction type of UV ink. Although a radical polymerization method is used in this embodiment, a cationic polymerization method may be used instead.

In the radical polymerization method, various types of acrylic monomers or oligomers are used as a curing component. The monomer indicates a molecule capable of forming a constituent element of a basic structure of a high molecular weight material. Examples of the monomer include a monofunctional monomer and a polyfunctional monomer (including a difunctional monomer). For example, isobonyl acrylate or phenoxyethyl acrylate may be used as the monofunctional monomer, and trimethylol propane triacrylate or polyethylene glycol diacrylate may be used as the polyfunctional monomer. As the oligomer, for example, urethane acrylate may be used.

In addition, as a color material of the ink of this embodiment, a pigment is used. An inorganic or an organic pigment may be used as the pigment without any particular limitation. Examples of the inorganic pigment include titanium oxide and iron oxide. Examples of the organic pigment include an azo pigment (an azo chelate pigment, an insoluble azo pigment, or the like), a polycyclic pigment, a dye chelate pigment, and a nitro pigment.

Various types of aromatic ketones, such as benzophenone and phenyl phosphine oxide, are used as the photopolymerization initiator. In the radical polymerization method, when light is radiated to ink containing the photopolymerization initiator mentioned above, the photopolymerization initiator contained in the ink absorbs light having a specific wavelength to generate radicals. In addition, the radicals thus generated attack a monomer to advance a polymerization reaction (curing proceeds).

The amount of the photopolymerization initiator added in the ink composition is preferably 0.1 to 15 percent by mass and more preferably 0.5 to 10 percent by mass. When the added amount is smaller than desired, the influence of oxygen inhibition becomes significant due to a low polymerization rate, and as a result, a curing defect may occur. On the other hand, when the added amount is larger than needed, a cured material has a low molecular weight, and an oxide film having a low durability can only be obtained.

The UV ink of this embodiment contains two types of photopolymerization initiators. One photopolymerization initiator (hereinafter referred to as “photopolymerization initiator A”) has a sensitivity at a peak (390 nm) of the wavelength of the light source of the temporary-curing radiation portion 42, and the other photopolymerization initiator (hereinafter referred to as “photopolymerization initiator B”) has a sensitivity at a wavelength shorter than the wavelength of the light source of the temporary-curing radiation portion 42 (the sensitivity is low at the peak of the wavelength of the light source of the temporary-curing radiation portion 42).

In this embodiment, Irgacure-784, Irgacure-819, and Chemcure-TPO are used as the photopolymerization initiator A. In addition, Chemcure-09 and Chemcure-73 are used as the photopolymerization initiator B.

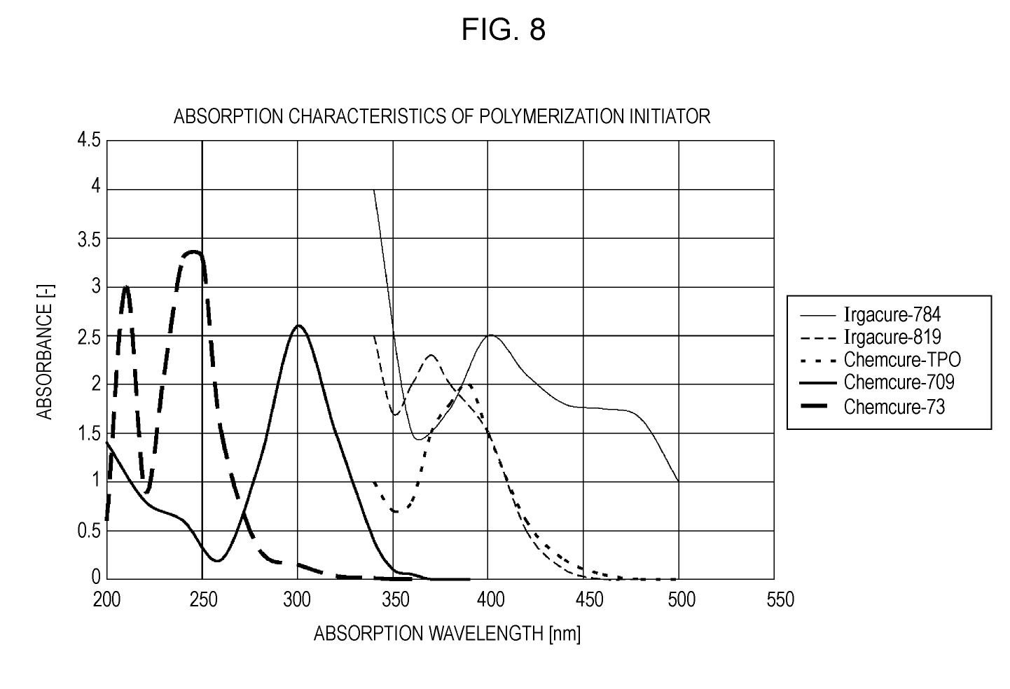

FIG. 8 shows absorption characteristics of the photopolymerization initiators. The horizontal axis of FIG. 8 indicates the wavelength (absorption wavelength), and the vertical axis of FIG. 8 indicates the absorbance (sensitivity).

As shown in FIG. 8, Irgacure-784, Irgacure-819, and Chemcure-TPO, each of which is the photopolymerization initiator A, have a sensitivity at a peak (390 nm) of the wavelength of the light source of the temporary-curing radiation portion 42.

The sensitivity of Irgacure-784 has a peak at a wavelength (approximately 400 nm) slightly longer than the peak of the wavelength of the light source of the temporary-curing radiation portion 42. In addition, among the photopolymerization initiators, Irgacure-784 has the highest sensitivity at a long wavelength (500 nm).

Irgacure-819 has a sensitivity at a wavelength up to approximately 450 nm, and the sensitivity thereof has a peak at a wavelength (approximately 370 nm) slightly shorter than the peak of the wavelength of the light source of the temporary-curing radiation portion 42.

Chemcure-TPO has a sensitivity at a wavelength up to approximately 460 nm, and the sensitivity thereof has a peak in the vicinity of the peak (approximately 390 nm) of the wavelength of the light source of the temporary-curing radiation portion 42.

On the other hand, Chemcure-709 and Chemcure-73, each of which is the photopolymerization initiator B, have a very low sensitivity at the peak (approximately 390 nm) of the wavelength of the light source of the temporary-curing radiation portion 42.

The sensitivity of Chemcure-709 has a peak at a wavelength (300 nm) shorter than the peak of the wavelength of the light source of the temporary-curing radiation portion 42.

The sensitivity of Chemcure-73 has a peak at a further shorter wavelength side (wavelengths: approximately 240 and 210 nm) than that of Chemcure-709.

The photopolymerization initiators (photopolymerization initiators A), that is, Irgacure-784, Irgacure-819, and Chemcure-TOP, are likely to generate radicals by UV radiation of the temporary-curing radiation portion 42, and the photopolymerization initiators (photopolymerization initiators B), that is, Chemcure-709 and Chemcure-73, are not likely to generate radicals by UV radiation of the temporary-curing radiation portion 42. In addition, as described above, since the light source of the complete-curing radiation portion 44 has a wide wavelength band of the light emission distribution, Chemcure-709 and Chemcure-73 generate radicals by UV radiation of the complete-curing radiation portion 44 and promote the photopolymerization reaction.

In addition, as shown in the ink composition of FIG. 7, the content of the photopolymerization initiator A is 0.2 to 0.5 percent by mass, and the content of the photopolymerization initiator B is 4 to 5 percent by mass. As described above, the content of the photopolymerization initiator B having a low sensitivity at the wavelength of the light source of the temporary-curing radiation portion 42 is set large. Accordingly, even with a large number of UV radiations for temporary curing, the ink is not completely cured.

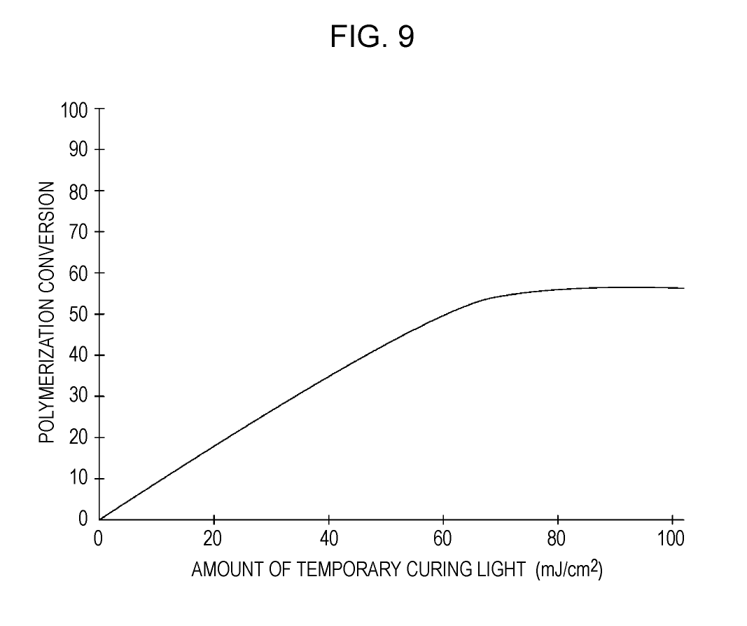

FIG. 9 is a graph showing one example of the relationship between the amount of light (amount of UV radiation) for temporary curing of the UV ink of this embodiment and the polymerization conversion ratio. The horizontal axis of the graph indicates the amount of light radiated to a dot by the temporary-curing radiation portion 42 and the vertical axis indicates the ratio of the polymerization conversion. In this graph, a high polymerization conversion ratio indicates that the photopolymerization reaction is advanced. In this embodiment, the polymerization conversion ratio is obtained by measurement of double bond absorbance using an FT-IR spectrum.

As shown in the graph, when the amount of light is 60 mJ/cm² or less, the ratio of the polymerization conversion increases as the amount of light is increased. However, when the amount of light is more than 60 mJ/cm², the polymerization conversion ratio is approximately constant (approximately 55%) even if the amount of light is increased. That is, when the amount of light is more than 60 mJ/cm², curing is not further advanced even if UV for temporary curing is radiated. The reason for this is that since the amount of the photopolymerization initiator A is small, when the amount of UV radiation for temporary curing is increased, the photopolymerization initiator A no longer generates radicals at a certain level, and the photopolymerization reaction is not advanced.

The UV ink of this embodiment contains the photopolymerization initiator B (Chemcure-709 or Chemcure-73) having no sensitivity at wavelengths for the temporary curing and having a sensitivity at a wavelength shorter than that for the temporary curing. Therefore, the photopolymerization reaction occurs (the polymerization conversion ratio increases), and the completely cured state can be obtained by radiation of UV having a wide band from the complete-curing radiation portion 44.

As described above, the UV ink which contains two types of photopolymerization initiators having sensitivities (absorption peaks) at different wavelengths is used in this embodiment. The amount of the photopolymerization initiator A having a high sensitivity at the wavelength of the light source of the temporary-curing radiation portion 42 is set small, and the amount of the photopolymerization initiator B having a low sensitivity at the wavelength of the light source of the temporary-curing radiation portion 42 is set large. Accordingly, regardless of the number of temporary curings (regardless of the amount of UV radiation) by the temporary-curing radiation portion 42, complete curing may not occur with the temporary curing (UV ink is still in a semi-cured state) but can be obtained by the complete curing.

The ratio (content ratio) between the photopolymerization initiator A and the photopolymerization initiator B may be changed between an ink ejected from a head at the upstream side in the transport direction and an ink ejected from a head at the downstream side in the transport direction. Accordingly, dots formed by the individual heads can be temporarily cured so as not to be completely cured.

For example, as described above, the UV ink ejected from the head at the upstream side in the transport direction receives a large number of UV radiations for temporary curing. Hence, the ratio of the photopolymerization initiator A may be decreased, and the ratio of the photopolymerization initiator B may be increased in the UV ink ejected from the head at the upstream side in the transport direction. Accordingly, even through a large number of UV radiations for temporary curing, complete curing can be prevented.

On the other hand, the UV ink ejected from the head at the downstream side in the transport direction receives a small number of UV radiations for temporary curing. Hence, the ratio of the photopolymerization initiator A may be increased, and the ratio of the photopolymerization initiator B may be decreased in the UV ink ejected from the head at the downstream side in the transport direction. Accordingly, since the number of UV radiations for temporary curing is small, no complete curing occurs until the complete curing is performed.

### Other Embodiments

The above embodiment is described for understanding of the invention, but the invention is not limited to the embodiment. The invention may be changed and modified without departing from the scope of the invention, and all equivalents are included therein. In particular, the following embodiments are also included in the invention.

### Printer

In the above embodiment, as one example of the printing system, the printer is described. However, the printing system is not limited thereto. Examples of a method for ejecting an ink from a nozzle include a thermal method in which a bubble is generated in a nozzle using a heat emission element to eject a liquid by the bubble in addition to a piezoelectric method in which an ink chamber is expanded or contracted by applying a voltage to a drive element (piezoelectric element) to eject a fluid.

Although the line printer is described in this embodiment, the UV ink according to the embodiment may be used in a printer other than that described above. For example, there may be used a printer in which a plurality of heads and a plurality of UV radiation sections (of a temporary-curing radiation portion) are alternately provided to face a circumferential surface of a cylindrical transport drum. In addition, there may also be used a printer in which a transport operation transporting a medium in a transport direction and a dot forming operation forming a dot on the medium by intermittently ejecting an ink while a head is moved in a direction intersecting the transport direction are alternately repeated to print an image.

### Ink

Although the UV ink of the embodiment described above contains two types of photopolymerization initiators, at least two types thereof may be contained. At least one type thereof may have a low sensitivity at the wavelength of the light source of the temporary-curing radiation portion 42. In addition, in this embodiment, although Irgacure-784, Irgacure-819, Chemcure-TPO, Chemcure-09, and Chemcure-73 are used as the photopolymerization initiators, other photopolymerization initiators than those described above may also be used.

In addition, in the above embodiment, the “ultraviolet ray (UV) curable ink” is described as the photocurable ink by way of example. However, the photocurable ink is not limited thereto. For example, an ink to be cured by light, such as electron rays, X rays, visible light rays, or infrared rays, may also be used.

The entire disclosure of Japanese Patent Application Nos: 2009-195939, filed Aug. 26, 2009 and 2010-114549, filed May 18, 2010 are expressly incorporated by reference herein.

What is claimed is:

1. A printing system comprising:
a temporary-curing light source radiating temporary-curing light to dots formed on a medium; and
a complete-curing light source radiating complete-curing light to the dots irradiated with the temporary-curing light and having a wavelength band different from that of the temporary-curing light source,
wherein ink used for forming the dots includes at least two types of photopolymerization initiators which photopolymerize a monomer when being irradiated with light, and
the two types of photopolymerization initiators have absorption peaks at different wavelengths.

2. The printing system according to claim 1,
wherein the complete-curing light source and the temporary-curing light source have different wavelength distributions from each other,
the two types of photopolymerization initiators are a first photopolymerization initiator which is likely to generate radicals by radiation of light from the temporary-curing light source and a second photopolymerization initiator which is likely to generate radicals by radiation of light from the complete-curing light source, and
a polymerization conversion ratio of the monomer by the complete-curing light source is higher than that of the monomer by the temporary-curing light source.

3. The printing system according to claim 2,
wherein the temporary-curing light source has a single peak at approximately 390 nm and the complete-curing light source has a plurality of peaks in the wavelength range of 200 to 600 nm, and
the two types of photopolymerization initiators include one of Irgacure-784, Irgacure-819, and Chemcure-TPO as the first photopolymerization initiator and one of Chemcure-709 and Chemcure-73 as the second photopolymerization initiator.

4. The printing system according to claim 3,
wherein the ink contains 0.2 to 0.5 percent by mass of the first photopolymerization initiator and 4 to 5 percent by mass of the second photopolymerization initiator.
